(19) United States
(12) Patent Application Publication
(10) Pub. No.: US 2007/0176889 A1
(43) Pub. Date: Aug. 2, 2007

(54) Electrophoretic display with cyclic rail stabilization

(75) Inventors: Guofu Zhou, Best (NL); Mark T. Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/597,830

(22) PCT Filed: Feb. 8, 2005
(86) PCT No.: PCT/IB05/50501

§ 371 Date: Aug. 9, 2006

Related U.S. Application Data
(60) Provisional application No. 60/543,730, filed on Feb. 11, 2004.

(51) Int. Cl. G09G 3/34

(52) U.S. Cl. 345/107

(57) ABSTRACT

An image is updated on a bi-stable display (310) such as an electrophoretic display by using cyclic rail-stabilized driving, where an image transition is realized either directly via a single drive pulse (D1), or indirectly via a reset pulse (R) and a drive pulse (D2) of opposite polarity. First shaking pulses (S1) are applied to the bi-stable display, when the at least one image transition is realized indirectly, e.g., during at least a portion of the reset pulse and/or the drive pulse of opposite polarity. Furthermore, second shaking pulses (S2) are applied prior to the single drive pulse, or prior to the reset pulse and the drive pulse of opposite polarity. The shaking pulses in either case may include initial shaking pulses (810, 820) and final shaking pulses (815, 825), which have a reduced energy.

The invention relates generally to electronic reading devices such as electronic books and electronic newspapers and, more particularly, to a method and apparatus for reducing image retention effects in a display.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003-Symposium on Information Displays. May 18-23, 2003, -digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, it is problematic that image retention effects are often visible on an electrophoretic display.

The invention addresses this problem by providing a method and apparatus for reducing image retention effects in a display.

In a particular aspect of the invention, a method for driving a bi-stable display includes driving the bi-stable display using cyclic rail-stabilized driving for at least one image transition, wherein the at least one image transition is realized either directly via a single drive pulse, or indirectly via a reset pulse followed by a drive pulse of opposite polarity, and applying at least one set of shaking pulses to the bi-stable display, when the at least one image transition is realized indirectly.

A related electronic reading device and program storage device are also provided.

### IN THE DRAWINGS

FIG. 1 shows diagramatically a front view of an embodiment of a portion of a display screen of an electronic reading device;

FIG. 2 shows diagramatically a cross-sectional view along 2-2 in FIG. 1;

FIG. 3 shows diagramatically an overview of an electronic reading device;

FIG. 4 shows diagramatically two display screens with respective display regions;

FIG. 5 illustrates a cyclic rail-stabilized driving scheme;

FIG. 6 illustrates an example waveform for representative transitions where shaking pulses are applied prior to reset pulses;

FIG. 7 illustrates the example waveform of FIG. 6 where shaking pulses are applied during reset pulses; and

FIG. 8 illustrates the example waveform of FIG. 7 where the shaking pulses include pulses with varying energy.

In all the Figures, corresponding parts are referenced by the same reference numerals.

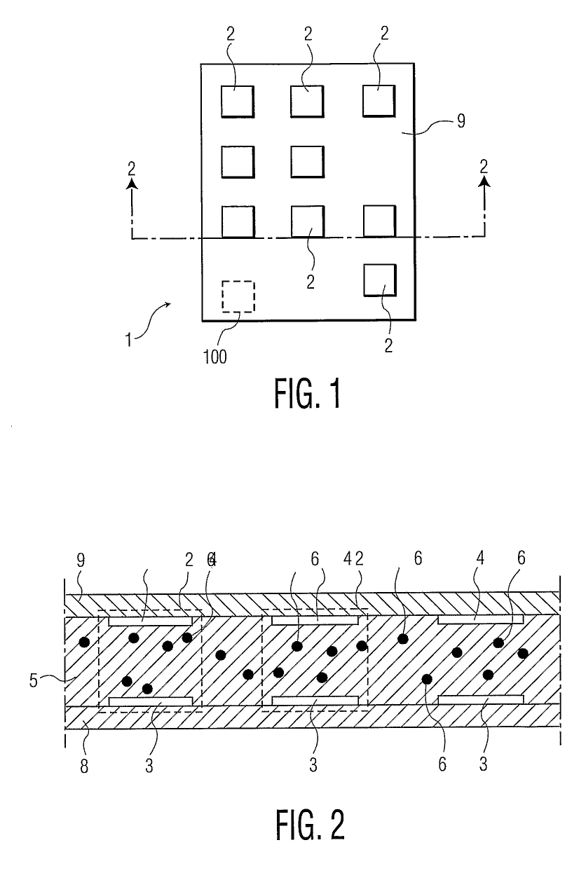

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may provide voltage waveforms, via an addressing circuit 305, to the different pixels in the display screen 310. The addressing circuit 305 provides information for addressing specific pixels, such as row and column, to cause the desired image or text to be displayed. As described further below, the display ASIC 100 causes successive pages to be displayed starting on different rows and/or columns. The image or text data may be stored in a memory 320, which represents one or more storage devices. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art. The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 based on information stored in the memory 320, as discussed further below.

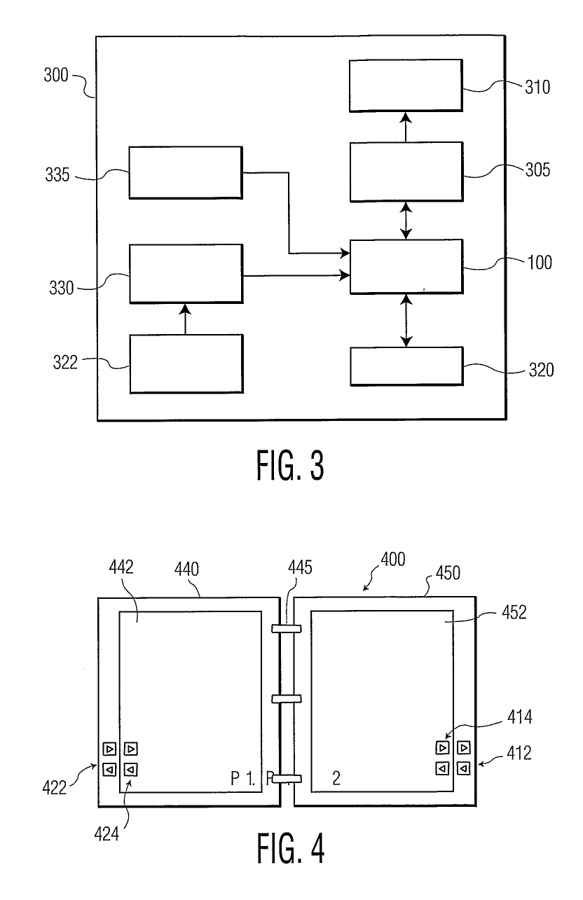

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

### PROBLEM TO BE SOLVED

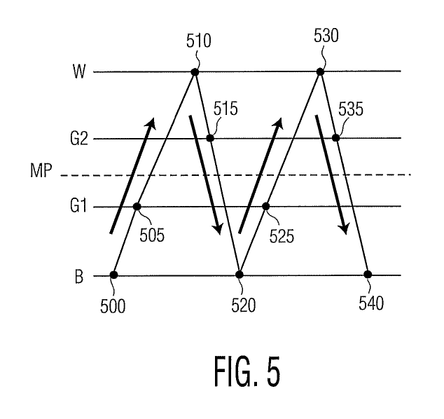

Grey levels in electrophoretic displays are strongly influenced by factors such as image history, dwell time, temperature, humidity, and lateral inhomogeneity of the electrophoretic foils. It has been demonstrated that accurate grey or other color levels can be achieved using a rail-stabilized approach where the grey levels are always achieved either from a reference black or reference white state (the two rails). Moreover, in order to obtain dc-balanced driving, a cyclic rail-stabilized greyscale (C-RSGS) concept was recently introduced, which is illustrated in FIG. 5. This concept is discussed further in U.S. patent application publication no. 2003/0137521, dated Jul. 24, 2003.

FIG. 5 illustrates a cyclic rail-stabilized driving scheme. In the C-RSGS method, the ink or other bi-stable material must always follow the same optical path between the two extreme optical states: full black and full white (the two rails), regardless of the image sequence, as indicated by the arrows in FIG. 5. In this example, the display has four different optical states: black (B), dark grey (G1), light grey (G2) and white (W). Image transitions that do not require crossing of the midpoint (MP) are realized directly, while transitions that do require crossing of the midpoint (MP) are realized indirectly, via a reset to the opposite rail followed by a drive pulse of opposite polarity. For example, transitions from B (point 500) to G1 (point 505 or 525), from G1 (point 505 or 525) to W (point 510 or 530), from W (point 510 or 530) to G2 (point 515 or 535), and from G2 (point 515 or 535) to B (point 520 or 540), are realized directly by applying a single drive pulse to the display that causes the particles to move in the direction of the arrow.

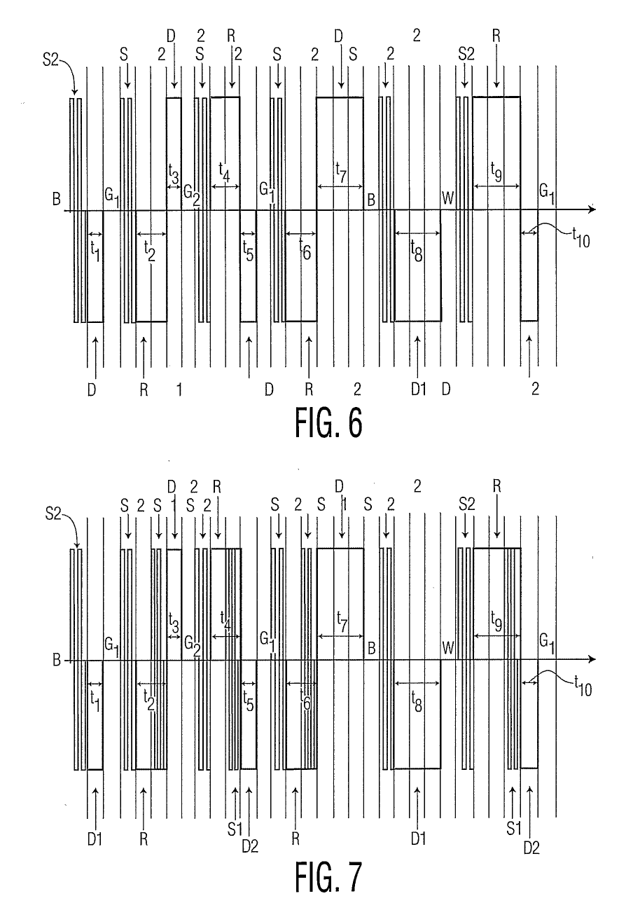

On the other hand, transitions, for example, from B (point 500, 520 or 540) or G1 (point 505 or 525) to G2 (point 515 or 535) are realized indirectly via the rail that is opposite to the starting point, G1 (point 505 or 525). In this case, a reset pulse is applied to cause the particles to move to the opposite rail, W (point 510 or 530), and a subsequent drive pulse of opposite polarity is applied to cause the particle to move to the final state, G2 (point 515 or 535). Various other transitions that are realized indirectly should be apparent, e.g., B (point 500) to B (point 520), G1 (point 505) to B (point 520), and G2 (point 515) to G1 (point 525), W (point 530), and G2 (point 535). A corresponding driving waveform is schematically shown in FIG. 6 for representative image transitions.

FIG. 6 illustrates an example waveform for representative transitions where second shaking pulses (S2) are applied prior to a single drive pulse (D1), and prior to a reset pulse (R) that is followed by a drive pulse (D2) of opposite polarity. First shaking pulses (S1) are discussed in connection with FIG. 7. Three different image histories are shown for transitions to G1, e.g., B to G1, G2 to G1, and W to G1. For simplicity, a pulse width modulated (PWM) driving scheme is shown for a display with ideal ink materials, which are insensitive to dwell time and image history. However, other driving schemes may be used, such as voltage modulated driving, or a combination of PWM and VM. On the horizontal axis, the image states B, G1, G2, G1, B, W and G1 are realized using the cyclic rail-stabilized driving scheme of FIG. 5. Thus, the transition from B (e.g., point 500) to G1 (e.g., point 505) is realized directly by applying a single drive pulse (D1) with a duration t₁. The transition from G1 (e.g., point 505) to G2 (e.g., point 515) is realized indirectly via the rail W (e.g., point 510) by applying a reset pulse (R) with a duration t₂ to drive the display from G1 (point 505) to W (point 510) followed by a drive pulse (D2) of opposite polarity with a duration t₃ to drive the display from W (point 510) to G2 (point 515). The durations of the reset pulse (R) and drive pulse (D2) are proportional to the distance that the particles in the display must move to reach the new greyscale state. For example, t₂ is twice the duration of t₃ since the distance from G1 (point 505) to W (point 510) is twice the distance from W (point 510) to G2 (point 515). The distance between two optical states mentioned above is to be understood as a brightness difference between the two states.

The transition from G2 (point 515) to G1 (point 525) is also realized indirectly, via the rail B (e.g., point 520), by applying a reset pulse (R) with a duration 4 to drive the display from G2 (point 515) to B (point 520), followed by a drive pulse (D2) of opposite polarity with a duration t₅ to drive the display from B (point 520) to G1 (point 525). The transition from G1 (point 525) to B (point 540) is also realized indirectly, via the rail W (point 530), by applying a reset pulse (R) with a duration t₆ to drive the display from G1 (point 525) to W (point 530), followed by a drive pulse (D2) of opposite polarity with a duration t₇ to drive the display from W (point 530) to B (point 540). In this case, the duration of t₇ is one and one-half times the duration of t₆.

The transition from B (point 540 or equivalently, point 500) to W (point 510) is realized directly by applying a single drive pulse (D1) with a duration t₈ to drive the display from B (point 500) to W (point 510). Finally, the transition from W (point 510) to G1 (point 525) is realized indirectly, via the rail B (point 520), by applying a reset pulse (RI) with a duration t₉ to drive the display from W (point 510) to B (point 520), followed by a drive pulse (D2) of opposite polarity with a duration t₁₀ to drive the display from B (point 520) to G1 (point 525). In this case, the duration of t₉ is three times the duration of t₁₀.

Due to the cyclic character of the image transitions, the total energy, expressed by time×voltage, of one or more successive negative pulses is equal to that of the one or more successive and subsequent positive pulses. For example, if the present image is at the black state (B), referring to the leftmost state on the horizontal axis in FIG. 6, and the next image to be displayed is dark grey (G1), a negative drive pulse (D1) with a duration t₁ that is 1/3 of the full pulse width is applied. After a waiting period or dwell time, the image state G2 is displayed on the pixel. A negative reset pulse (R) with a duration t₂ that is 2/3 of the full pulse width is used, directly followed by a positive drive pulse (D2) with a duration t₃ that is 1/3 of the full pulse width. Next, the G1 state is displayed after another dwell time. A positive reset pulse (R) with a duration t₄ that is 2/3 of the full pulse width is used, directly followed by a negative drive pulse (D2) with a duration t₅ that is 1/3 of the full pulse width. The ink or other bi-stable material follows the direction of the arrows indicated in FIG. 5 so that: t₁+t₂=t₃+t₄=t₅+t₆=t₇=t₈=t₉ . . . In this way, DC-balanced driving is realized when PWM driving is applied and ideal ink is used. When other driving schemes such as VM or combined PWM and VM are used, and the ink is not ideal, DC balance is achieved by adhering to impulse potential theory. The waveform is then constructed so that there is no net impulse for all sets of image transitions that bring the display from an intermediate state through an arbitrary set of states and back to the initial state.

Note also in FIG. 6 that shaking pulses (S2), which can be helpful in reducing image retention effects, are provided prior to each transition. Shaking pulses are discussed in co-pending European patent application 02077017.8, entitled “Display device”, filed May 24, 2002, docket no. PHNL030441, incorporated herein by reference (or WO 03/079324, Electrophoretic Active Matrix Display Device”, published Sep. 25, 2003, docket no. PHNL 020441). The shaking pulses can be hardware or software shaking pulses. Hardware shaking pulses are applied to all pixels in the display together, while software shaking pulses are applied to one or more specific pixels.

Although the waveform shown in FIG. 6 significantly reduces the dimension of the transition matrix and the effects of dwell time, it would be desirable to reduce the image retention effects even further. Also, it would be desirable to improve both the accuracy and absolute level of the black and white states to provide a better appearance for the end user.

### PROPOSED SOLUTION

In accordance with the invention, techniques are proposed for reducing image retention and increasing contrast ratio in a bi-stable display such as an active matrix electrophoretic display using the cyclic rail-stabilized driving scheme. In one aspect of the invention, an additional set of shaking pulses is added to the waveforms used for the indirect transitions. The waveforms comprise voltage pulses that send the ink or other bi-stable material to one of the two extreme optical states: e.g., black and white. A shaking pulse is a voltage pulse representing energy sufficient for releasing the particles from their present positions but insufficient for moving the particles from the present positions to one of the extreme positions. These shaking pulses can be hardware and/or software shaking pulses. These additional shaking pulses may be applied prior to the portion of greyscale driving pulse in the waveform. The timing of the shaking pulses can be flexible, and can occur anytime after the start of the reset pulse (R) and before the completion of the following drive pulse (D2). For example, a set of shaking pulses can occur during the reset pulse, during the drive pulse, and/or during a gap, if present, between the reset and drive pulse. One set of shaking pulses can extend through both the reset and drive pulses or portions thereof. In another possible approach, a first set of shaking pulses occurs during the reset pulse, and a second set of shaking pulses occurs during the drive pulse. In another possible aspect of the invention, an additional set of shaking pulses is added to the single pulse waveforms used for the direct transitions.

FIG. 7 illustrates the example waveform of FIG. 6 where first shaking pulses (S1) are applied. In this approach, a first set of shaking pulses (S1) is added to the greyscale driving waveforms, particularly in the waveforms for a greyscale transition via one of the two extreme optical states: black and white. For image transitions via one of the two rails, e.g., indirect transitions, the first shaking pulses (S1) are added prior to the greyscale driving. These shaking pulses significantly reduce image retention and enhance contrast ratio. The number and duration/energy of these shaking pulses is not limited but should be selected with the goal of optimizing performance while minimizing optical flicker. A typical number of a set of shaking pulses can be, e.g., one to ten. A typical pulse time of a shaking pulse may be about 10 ms. Following the cyclic rule, dark grey-to-black and light grey-to-white transitions are realized via the opposite rail. These transitions therefore take the longest time of all transitions. It is therefore recommended riot to use too long of a super frame time, which is the time required to transition from the black rail to the white rail, because of the restriction on the total image update time. Using a super frame time of normally 300 ms, for instance, the display cannot reach the full black and/or full white state. The introduction of the set of shaking pulses (S1) will speed up the ink motion, resulting in a higher contrast.

In particular, the first shaking pulses (S1) may be applied during at least a portion of the reset pulse (R) and/or the following drive pulse (D2) for a indirect transition. In one possible approach, the first shaking pulses (S1) are applied during a terminal portion, e.g., at the end of, the reset pulse (R), and just prior to the drive pulse (D2). For example, the transition from G1 to G2, the second and third states along the horizontal axis in FIG. 7, on the left-hand side, is indirectly realized by apply a first, negative reset pulse (R) of duration t₂ followed by a second, positive drive pulse (D2) of duration t₃. The first shaking pulses (S1) are applied during the second half of the reset pulse (R). In the example shown, the energy of the second shaking pulses (S2) is slightly greater than the energy of the first shaking pulses (S1). However, other approaches are possible, such as having the same energy for the first and second shaking pulses.

In one possible variation, a time gap separates the reset pulse (R) and the subsequent drive pulse (D2). Shaking pulses can be provided during this gap. In another possibility, one set of shaking pulses is applied during one or more of the reset pulse (R), drive pulse (D2) and gap. In another possibility, one set of shaking pulses is applied during the reset pulse (R), and another set of shaking pulses is applied during the drive pulse (D2). Further variations are possible.

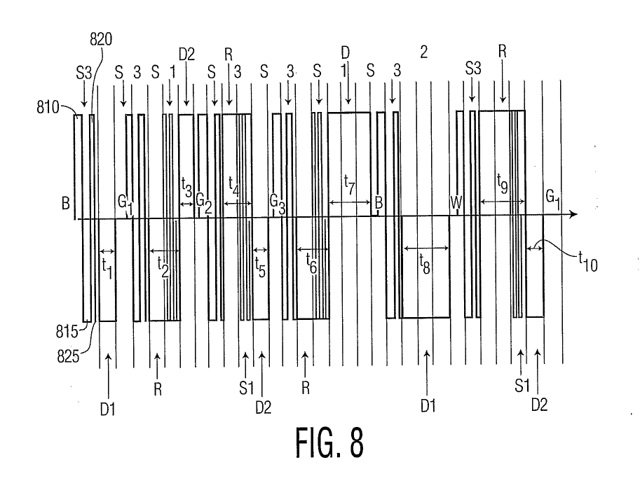

FIG. 8 illustrates the example waveform of FIG. 7 where the second shaking pulses have pulses with varying energy. Generally, the shaking pulses can comprise individual pulses with different energies, e.g., varying durations. In one approach, one or more initial shaking pulses have a higher energy than one or more subsequent final shaking pulses, e.g., in a group or set of shaking pulses. That is, the energy of each shaking pulse may be a decreasing function as the number of pulse increases. For example, a first shaking pulse in a set of shaking pulses may have the highest energy while the last shaking pulse in the set has the lowest energy. This approach can be used for either or both of the shaking pulses S1 and S2. In this way, the effects of dwell time, image history, and image retention are minimized without increasing flicker visibility. Also, a whiter white state and a darker black state are obtained, which is desirable for the end user.

In the example shown, modified shaking pulses (S3) include individual shaking pulses with varying energies within a set of shaking pulses. The modified shaking pulses (S3) may include a set of, e.g., four shaking pulses, where, in a given set, the initial shaking pulses, e.g., pulses 810 and 815, have a longer pulse time/energy, than the final shaking pulses, e.g., pulses 820 and 825. Providing the later pulses in a set of shaking pulses with a reduced energy relative to the earlier pulses in the set has been shown to be advantageous. In fact, it has been experimentally demonstrated that, when the initial shaking pulses have a longer duration than the final shaking pulses within the set of shaking pulses (S3), the increased pulse time in the initial shaking pulses has a similar effect on reducing flicker as do the final shaking pulses, but the effects of dwell time, image history and image retention are more effectively reduced, while contrast ratio is enhanced.

However, other variations are possible, such as providing the later shaking pulses in a set of pulses with a greater energy relative to the earlier pulses. It is also possible to have a high, low, high, low distribution of energy for successive pulses in a set, or high, low, low, high, or low, high, high, low and so forth. Each individual pulse can have a different energy, or groups of two or more can have the same energy while other groups have a different energy, and so forth. Moreover, some sets of shaking pulses can have individual pulses with varying energy while other sets of pulses have individual pulses with the same energy.

Note that, in the above examples, pulse-width modulated (PWM) driving is used for illustrating the invention, where the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. The invention is also applicable to color bi-stable displays. Also, the electrode structure is not limited. For example, a top/bottom electrode structure, honeycomb structure or other combined in-plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for driving a bi-stable display, comprising:
driving the bi-stable display (310) using cyclic rail-stabilized driving for at least one image transition, wherein the at least one image transition is realized either directly via a single drive pulse (D1), or indirectly via a reset pulse (R) and a drive pulse (D2) of opposite polarity; and
applying at least one set of shaking pulses (S1) to the bi-stable display, when the at least one image transition is realized indirectly.

2. The method of claim 1, wherein:
the applying the at least one set of shaking pulses comprises applying a first set of shaking pulses (S1) to the bi-stable display during at least a portion of the reset pulse (R).

3. The method of claim 1, wherein:
the applying the at least one set of shaking pulses comprises applying a first set of shaking pulses (S1) to the bi-stable display during at least a portion of the drive pulse (D2) of opposite polarity.

4. The method of claim 1, wherein:
the applying the at least one set of shaking pulses comprises applying a first set of shaking pulses to the bi-stable display during at least a portion of a gap between the reset pulse (R) and the drive pulse (D2) of opposite polarity.

5. The method of claim 1, wherein:
the applying the at least one set of shaking pulses comprises applying a first set of shaking pulses to the bi-stable display during at least a portion of the reset pulse (R) and the drive pulse (D2) of opposite polarity.

6. The method of claim 1, wherein:
the applying the at least one set of shaking pulses comprises applying a first set of shaking pulses to the bi-stable display during at least a portion of the reset pulse (R), and applying a second set of shaking pulses to the bi-stable display during at least a portion of the drive pulse (D2) of opposite polarity.

7. The method of claim 1, wherein:
the at least one set of shaking pulses includes at least one initial shaking pulse and at least one final shaking pulse; and
an energy of the at least one initial shaking pulse is greater than an energy of the at least one final shaking pulse.

8. The method of claim 1, further comprising:
applying a second set of shaking pulses (S2) to the bi-stable display prior to the single drive pulse (D1), when the at least one image transition is realized directly, and prior to the reset pulse (R) and the drive pulse (D2) of opposite polarity, when the at least one image transition is realized indirectly.

9. The method of claim 8, wherein:
the second set of shaking pulses (S2) includes at least one initial shaking pulse (810) and at least one final shaking pulse (825); and
an energy of the at least one initial shaking pulse (810) is greater than an energy of the at least one final shaking pulse (825).

10. The method of claim 1, wherein:
the bi-stable display comprises an electrophoretic display.

11. A program storage device tangibly embodying a program of instructions executable by a machine to perform a method for updating an image on a bi-stable display, the method comprising:
driving the bi-stable display (310) using cyclic rail-stabilized driving for at least one image transition, wherein the at least one image transition is realized either directly via a single drive pulse (D1), or indirectly via a reset pulse (R) and a drive pulse (D2) of opposite polarity; and
applying at least one set of shaking pulses (S1) to the bi-stable display, when the at least one image transition is realized indirectly.

12. The program storage device of claim 11, wherein:
the at least one set of shaking pulses includes at least one initial shaking pulse and at least one final shaking pulse; and
an energy of the at least one initial shaking pulse is greater than an energy of the at least one final shaking pulse.

13. The program storage device of claim 11, wherein:
the bi-stable display comprises an electrophoretic display.

14. An electronic reading device, comprising:
a bi-stable display (310); and
a control (100) for updating an image on the bi-stable display by: (a) driving the bi-stable display (310) using cyclic rail-stabilized driving for at least one image transition, wherein the at least one image transition is realized either directly via a single drive pulse (D1), or indirectly via a reset pulse (R) and a drive pulse (D2) of opposite polarity, and (b) applying at least one set of shaking pulses (S1) to the bi-stable display, when the at least one image transition is realized indirectly.

15. The electronic reading device of claim 14, wherein:
the applying the at least one set of shaking pulses comprises applying a first set of shaking pulses (S1) to the bi-stable display during at least a portion of the reset pulse (R).

16. The electronic reading device of claim 14, wherein:
the applying the at least one set of shaking pulses comprises applying a first set of shaking pulses (S1) to the bi-stable display during at least a portion of the drive pulse (D2) of opposite polarity.

17. The electronic reading device of claim 14, wherein:
the applying the at least one set of shaking pulses comprises applying a first set of shaking pulses to the bi-stable display during at least a portion of a gap between the reset pulse (R) and the drive pulse (D2) of opposite polarity.

18. The electronic reading device of claim 14, wherein:
the at least one set of shaking pulses includes at least one initial shaking pulse and at least one final shaking pulse; and
an energy of the at least one initial shaking pulse is greater than an energy of the at least one final shaking pulse.

19. The electronic reading device of claim 14, wherein:
the control applies a second set of shaking pulses (S2) to the bi-stable display prior to the single drive pulse (D1), when the at least one image transition is realized directly, and prior to the reset pulse (R) and the drive pulse (D2) of opposite polarity, when the at least one image transition is realized indirectly;
the second set of shaking pulses (S2) includes at least one initial shaking pulse (810) and at least one final shaking pulse (825
an energy of the at least one initial shaking pulse (810) is greater than an energy of the at least one final shaking pulse (825).

20. The electronic reading device of claim 14, wherein:
the bi-stable display comprises an electrophoretic display.
